(19) United States
(12) Patent Application Publication
(10) Pub. No.: US 2017/0109789 A1
(43) Pub. Date: Apr. 20, 2017

(54) SYSTEM AND METHOD PROVIDING INFORMATION RELATING TO CUSTOMERS AND MERCHANTS

(71) Applicant: STREETCAST INC., Elora (CA)

(72) Inventors: Harry Richmond MAJOR, Waterloo (CA); Ramsey Jackson MARRA, Elora (CA); Elliot Vincent Mah, Vancouver (CA)

(21) Appl. No.: 15/295,147

(22) Filed: Oct. 17, 2016

Related U.S. Application Data
(60) Provisional application No. 62/242,507, filed on Oct. 16, 2015.

(51) Int. Cl. G06Q 30/02

(52) U.S. Cl. CPC G06Q 30/0261; G06Q 30/0269

(57) ABSTRACT

Systems and methods are described for calculating, storing and delivering data to merchants' data terminals regarding the number and characteristics of nearby potential customers. Advertisements from the merchant data terminals are stored in a database, and selectively distributed to nearby potential customer data terminals. Advertisement data structures also support start and end times for the advertisement from the merchant. The system is additionally configured to incorporate information regarding classifications and interests of both the customer and merchant. Another aspect of the system supports coupons, special offers, and affinity points.

### BACKGROUND

Field of the Invention

The present invention relates to providing information relating to customers and merchants.

Description of the Related Art

Companies, and in particular merchants, spend a great deal of time and effort promoting their products and services. Traditionally, these methods include signage, direct advertising in media such as print, radio, television, billboards and the like. Recently, advertising to computing devices such as computers and mobile phones has created a new medium for advertising. These mediums include sub-categories such as web-page based advertising, social media based advertising, and email advertising.

Many businesses find that these advertising methods are ineffective as they can be expensive and not targeted at potential customers who are nearby and have the attributes of a customer prepared to make a purchase.

A further frustration for businesses is that they must develop their advertising messages without knowledge of the characteristics of potential customers who are nearby or prepared to make a purchase.

What is needed is an improved method to identify and inform selected potential customers about offers, and to provide information to businesses to allow them to dynamically change these offers.

### SUMMARY

The system is disclosed that provides a method of visualizing the quantity and distribution of qualified customers who are presently proximal to a vendor location, and possess various attributes. In one embodiment, the vendor is provided with an application on a handheld device that can a) determine the proximity and characteristics of nearby potential customers and b) provide a mechanism to provide messaging to these nearby potential customers in order to solicit interest in events, goods or services offered.

In one embodiment, the characteristics of the nearby potential customers could include, but are not limited to, demographic data such as age, distance from home address, gender, income, hobbies, ethnicity, friend lists on various media sites, nationality, profession or other information.

Based on this information, the vendor can make a substantially more informed decision as to what offers to make to the population of nearby potential customers. These decisions can include offers based on pricing of the offer, duration of the offer, individual sub-groups to send the offer, language of the offer, approach of the offer, combined offers, conditions of the offer, and other customizable decisions.

In addition to the information given to nearby potential customers, the preferred embodiment also includes a facility to include information that characterizes both customer groups and vendor groups with helpful information categories. This information relates product and service attributes and categories to customer interest attributes and categories.

### BRIEF DESCRIPTION OF THE DRAWINGS

In order that the subject matter may be readily understood, embodiments are illustrated by way of examples in the accompanying drawings, in which:

FIG. 1 shows a diagram of an example of a simplified environment and process flow of the system;

FIG. 2 shows a simplified flow chart of the merchant offer process in the system;

FIG. 3 shows a simplified flow chart for the customer process in the system;

FIG. 4 shows the hardware components of the customer and merchant terminals;

FIG. 5 shows the server hardware and server connections;

FIG. 6 shows the data format used to encode a merchant offer;

FIG. 7 shows a screen view of a merchant offer.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

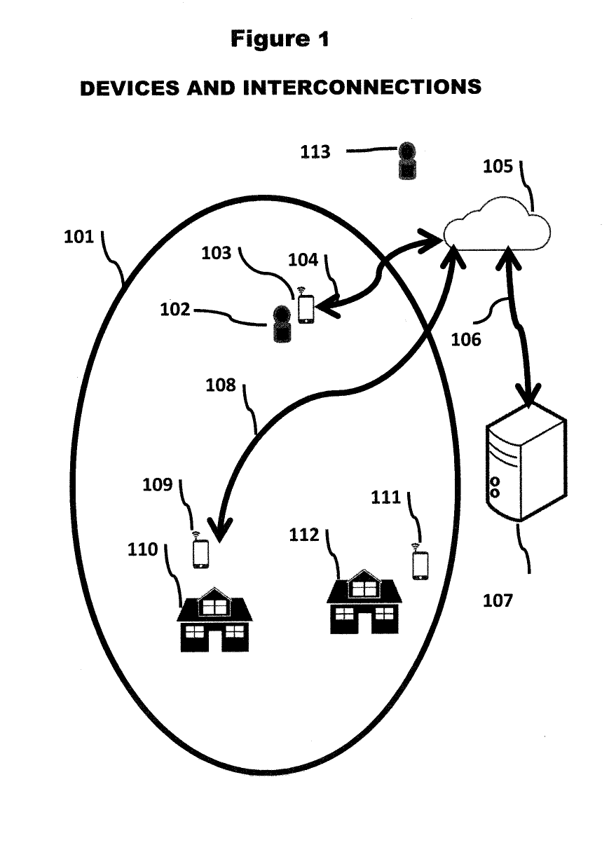

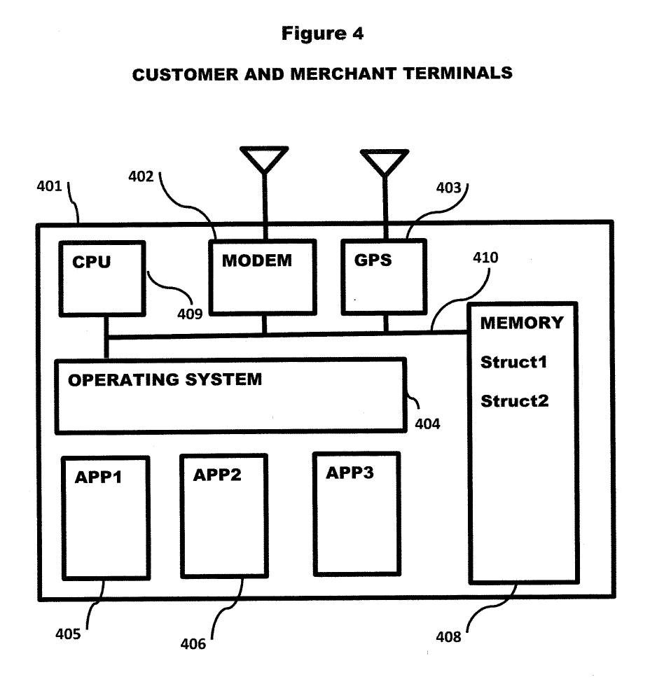

FIG. 1 shows a simplified diagram of one embodiment of the system. In this example, a geographic area 101 encloses a customer 102 with a mobile device 103 such as a smartphone, tablet, or other data terminal, operably connected via connection 104 to a telecommunications network 105 such as the internet. This connection is facilitated by a wireless modem and antenna (FIG. 4, 402) The location of the mobile device 103 is determined by interrogating a Global Positioning Service (GPS) or similar module inside the mobile device. Further details of the GPS module and the interconnections inside the mobile device are shown in FIG. 4, 403.

The position of the mobile device is sent to the host computer 107 as updates are required. Updates can be triggered at periodic intervals, detection of user activity, or detecting that the application is now in focus. In the preferred implementation, the location of the customer's mobile device is determined by a function call to Location Services from within the operating system, for example the iOS operating system by Apple Inc. This function returns the device's current latitude and longitude in a data structure. GPS is only one way to establish the location of a mobile device, several other methods such as using beacons, base stations, or triangulation are also well known.

The same geographic area 101 encloses two merchants 110 and 112, each of which contains a data terminal device (109,111), such as a smartphone, tablet, or other mobile computer device each operably connected via connection 108 to a telecommunications network 105 such as the internet. A host computer 107 is also operably connected to the internet so as to enable communications of information to each customer mobile device (103), and merchant data terminal devices (109,111). The merchant data terminal devices (109, 111) are used for configuring their respective merchant accounts, for viewing the proximity of customer devices who are tagged with various characteristics, and for generating advertising or offer content. For example, a merchant's data terminal device may show that a group of potential customers, all tagged with an interest in pizza have entered a geographical area 101 close to the physical location of his business. The merchant may decide then to create an offer responsive to this group of potential customers by offering a special, limited time offer on pizza.

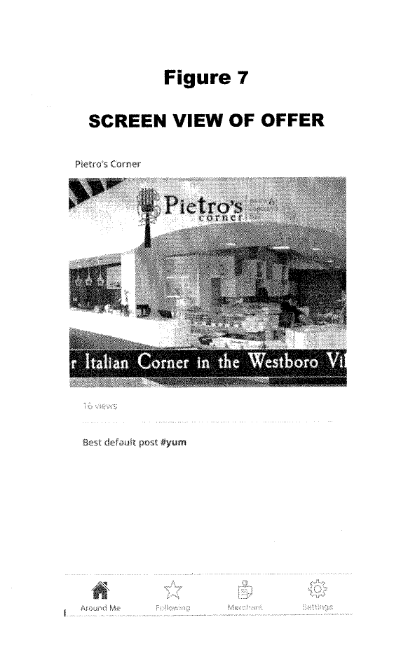

One way of tagging of interest in specific product areas, or of specific characteristics of offers is accomplished by adding the “#” character to a descriptive name string. These name strings (tags) can be compared for a match. Such a tag is shown in the user presentation of a merchant advertisement in FIG. 7 with the tag “#yum”, indicating that this merchant advertisement should be prioritized by customer mobile computer devices configured to be responsive to the tag “#yum”. Thus, matching tags can be used to prioritize offers in the list of merchant offers presented to the user.

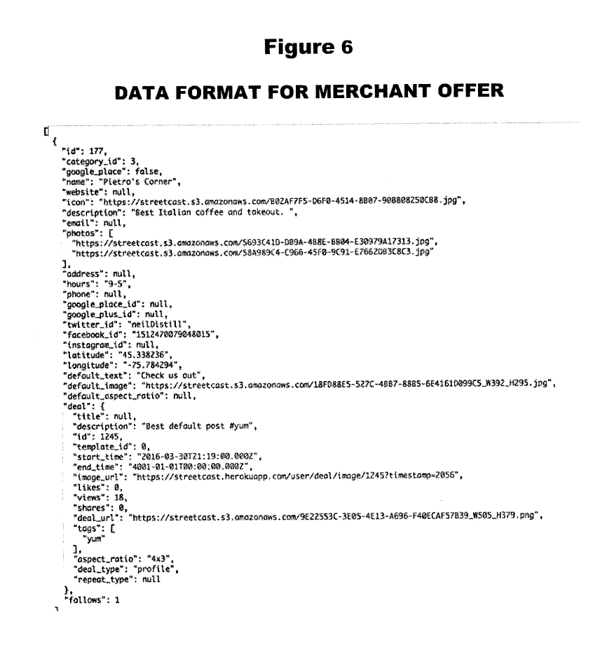

The merchant, in this situation, would then create advertising or offer content with the audio/visual and text tools found on most smartphones, tablets, or other computer devices. The offer is the sent via path 108 through the telecommunications network 105. Details on the format and content of the merchant offer can be found in FIG. 6.

The host computer then compares the proximity of each user to the location of the merchant who has created this advertising offer. One preferred way to evaluate proximity is to make use of the The Google Maps Distance Matrix API by Google Inc. Within this API, there is a function call that calculates the distance between two pairs of latitude and longitude. A list of nearby merchants can thus be determined by calculating the distance from the potential customer's mobile device to each merchant, and comparing the distance to a threshold value. From this list of nearby merchants, those merchants that have active offers can be selected, and a list of nearby active offers can be created for transmission to each potential customer.

The host computer 107 then sends the offer to each potential customer device within a certain radius. In one embodiment, the update is not periodic from the server, but is triggered by periodic location updates from each mobile potential customer device.

In this illustrative example, customer device 103 receives the advertising offer, whereas the customer 113, being outside geographic area 101, does not receive the offer on their mobile device (not shown). The application on the customer's mobile device 103 has a facility to present for review each offer delivered. The customer 102 decides if they want to respond to the offer by going to the location of the merchant. In alternative embodiments, the customer may respond in ways other than going to the physical location, for example by indicating interest or acceptance of the offer via their mobile device 103. In the preferred embodiment, the advertising messages have an expiry, and automatically delete from the customer's mobile device 103 to avoid cluttering the list of offers with old or expired offers. Potential customer experience is further enhanced by prioritizing the offers based on expressed interest in the form of tags, closer proximity to an offer, closeness to expiry of a particular offer, or other prioritizing schemes.

A further advantage is gained when the customer enters the merchant premises (110,112), and confirms that the specific advertisement sent by the merchant was effective. The information about customer response to advertising messages is a valuable tool for the merchant to continue to refine future advertising messages. More certain information about the effectiveness of the advertisement can be obtained by sending a code from the customer's mobile device 103 to the merchant's data terminal (109,111), in order to validate the advertised offer. The information can be collected, summarized and amalgamated into convenient and easy to understand formats such as dashboards or reports for the benefit of the merchant.

For illustrative purposes, a simple case is shown where the proximity to the merchant is a linear distance. Several enhancements and modifications to this simple model are possible, such as considering travel time to the merchant, direction of travel of the customer's device, likely means of transport in the area, geographical barriers, or other factors. Customers may also elect to be considered a part of a geographic area that they are not currently in, for example if they are away at work, but would still like to be informed of the offers in their home town, for example.

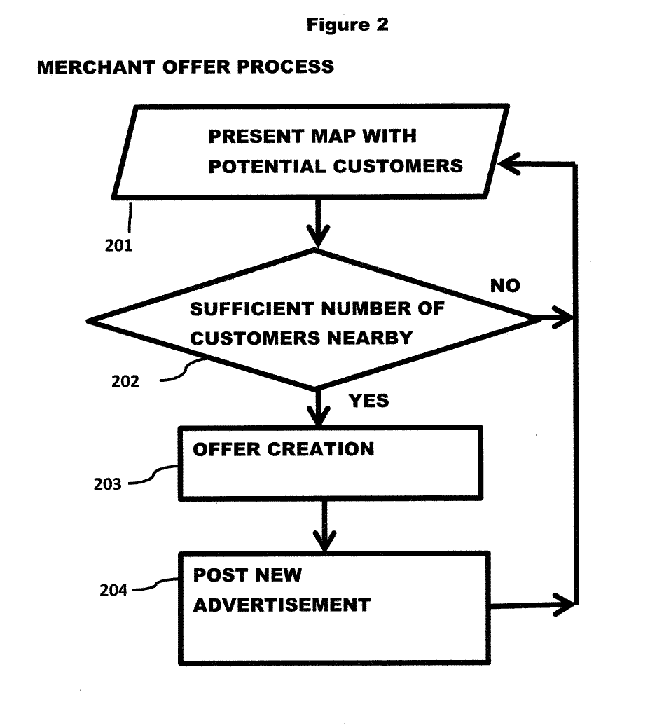

FIG. 2 shows a simplified decision flow for a merchant to create and distribute an offer to potential customers. In the first step 201, the merchant device (FIG. 4, 401) displays a map incorporated into the merchant application. This application is running on a data terminal device (109,111) and FIG. 4, 405, such as a smartphone, tablet, or general purpose computer device operably connected via connection 108 to a telecommunications network 105 such as the interne. In one embodiment, the merchant makes a visual determination by observing the potential customer markers or pins in the nearby vicinity on the map. The pins can contain further information regarding the classifications or type of customers that are nearby through several methods including color coding, additional information when hovering a cursor over the pin location, or sorting the map for pins representing specific characteristics.

In another embodiment, the step of determining whether a sufficient number of potential customers with specific characteristics are in an area of interest to the merchant can be partially or entirely completed with an algorithm that counts such potential customers and compares this number to a desired threshold value, thus assisting the merchant in making timely decisions regarding when to make additional offers to potential customers. In this manner, the merchant device can be configured to automatically create offers.

As an alternative to initiating the merchant offer process with by observing the number and type of nearby potential customers, the merchant device also permits direct entry of an advertisement in anticipation of additional potential customers entering the geographic area 101.

Another valuable tool for the merchant, is this system's ability to collect information about which tags or interests are trending among fellow merchants in the region. Merchants can associate categories or more specific tags with their offers, and the server can broadcast a report on which categories are trending, or being offered more frequently. This is of great benefit to merchants who can offer goods and services associated goods with that trend.

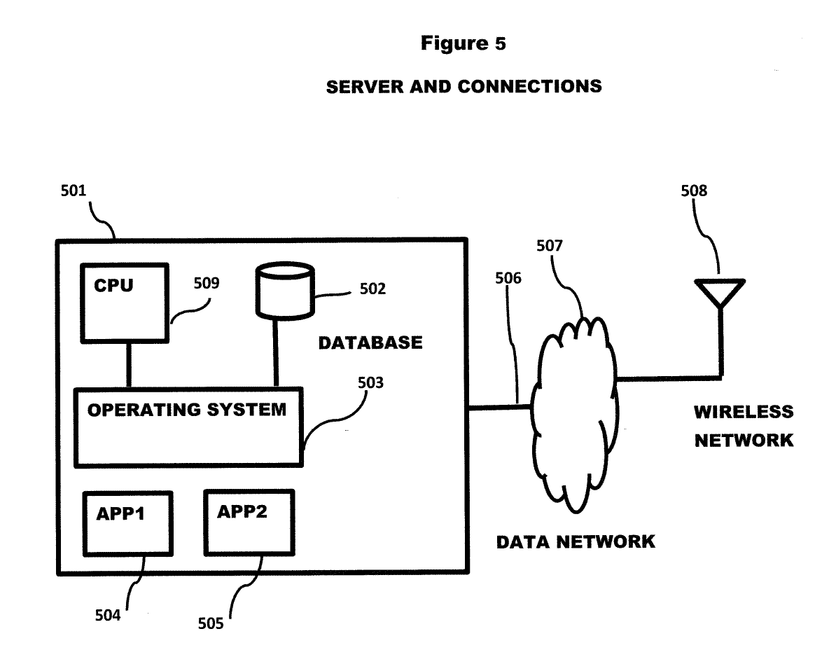

If there are sufficient potential customers in the vicinity, the merchant may elect to create an offer to these potential customer devices, providing an incentive or discount for the potential customer to visit the merchant. The offer, potentially including text and/or multimedia content is posted as an advertisement and stored in host computer 107. Specifically, these offers are stored in a database as shown in FIG. 5, 502.

Once the advertisement is posted, the process of looking for additional customers of different types relevant to the merchant is repeated.

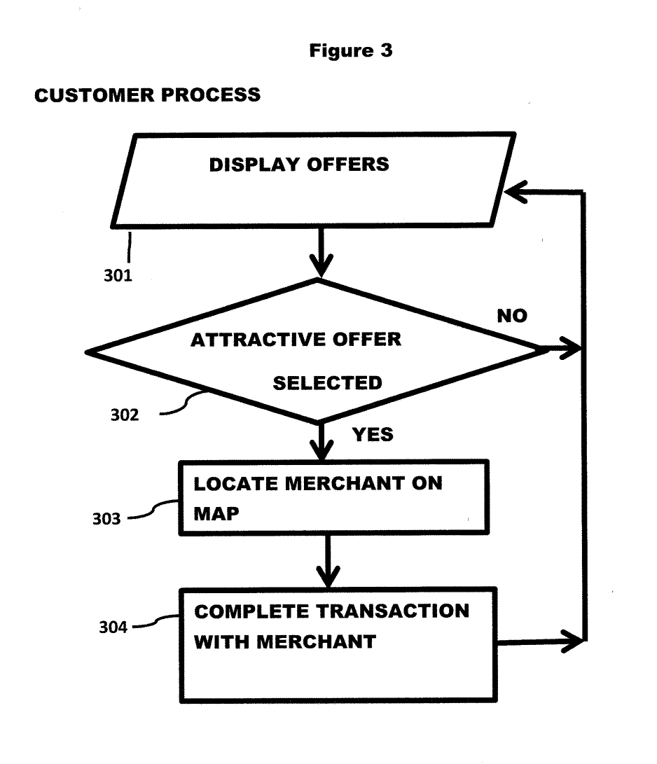

FIG. 3 shows an embodiment of the customer process that is used by potential customer 102 with software on mobile device 103. The customer's mobile device is sent a list of advertisements that are relevant to their current vicinity. While one embodiment focuses on distributing advertisements to potential customers in the vicinity, other implementations may additionally focus on user devices whose status indicates that interest in particular goods, locations, services, or themes related to the potential customers' interests. Advertising messages can be additionally sent to potential customers devices who have a high degree of match between the characteristics of an offer, and their personal interests.

In one embodiment, the list of offers is at least in part composed of offers that reside on or have been sent from the host computer 107. This list of advertisements can be browsed 301 by the potential customer until an attractive offer is found 302. The details of the offer format is shown in FIG. 6.

The potential customer's device selects a particular advertisement as an advertisement of interest, and enables sharing of this advertisement via a message to people known to them in their social media circles, such as email, Facebook, or other interest group. This sharing of offers encourages distribution of advertising messages beyond a group in the vicinity, to a group of people who may be additionally motivated to come to the vicinity for the offer.

When an attractive offer is found and selected, the application indicates the location of the merchant 303, either in text, visually on a map, through voice directions or some other means. In the preferred implementation, the iOS map application is passed the instruction to place a latitude/longitude marker on the merchant's location, which provides instructions to the potential customer to the merchant's location.

If no attractive offer is found by the potential customer, the potential customer can continue to browse the list of offers until an attractive offer appears. Directions on how to journey to the merchant from the potential customer's current location can also be indicated by the application FIG. 5, 504, 505. Details on how to provide directions between two known locations on a map are well known to application programmers, for example in the Google Maps Directions API.

Once the merchant is located, the potential customer has the option of completing the transaction 304 with the merchant. In addition to the option of accepting the offer from the advertisement, the merchant and potential customer also have the option of including extra or secondary transactions, such as discounts, competitions, affinity points, or further offers of goods or services. The application FIG. 5, 504, 505 can display notification of the receipt of the offer from the merchant's terminal by providing a visual indication in the form of the offer, as shown in FIG. 7. In addition, the application can display coupons in the form of authorization codes, machine readable codes such as barcodes or QR codes, or provide evidence of receiving the coupon by some other means such as NFC communications or wireless transmission.

FIG. 4 shows an example of the components and interconnections. These elements can be found in most current mobile phones or smartphones, such as the Apple iPhone by Apple Corp. Some additional features and hardware components such as LCD display and battery are not shown to highlight the components that are more directly used. Mobile device 401 contains hardware components such as CPU 409, MODEM 402, GPS 403, and memory 408. These hardware components are interconnected by means of electrical connections on the circuit board of the mobile phone, represented by the interconnecting bus 410. The CPU executes instructions from the operating system 404, in order to fulfil the basic operation of the mobile phone. An example of a suitable operating system is the iOS operating system by Apple Corp. The operating system additionally provides function calls to the applications, here APP1 405, APP2 406, APP3 407 to allow the applications to utilize the functions of the hardware components of the device. These function calls can be realized in many forms, including direct function calls, inter-process messaging or message queues.

The mobile device 401 is shown in FIG. 1, 103. The merchant's terminal hardware is also represented by 401, and is shown in FIGS. 1, 109 and 111. The difference between the merchant terminal and the customer terminal is in a configuration file residing in memory 408, mentioned as Struct1, that enables additional functionality of the application 405, such as posting new offers.

FIG. 5 shows a simplified diagram of the server and selected server connections. The server is also shown in FIG. 1, 107. The server provides storage for and distribution of merchant offers. Referring to FIG. 5, the server computer 501 contains with its enclosure a CPU 509 running an operating system 503. Applications APP1 504 and APP2 505 are stored on media connected to the server, loaded and executed within the operating system 503. The Apps are designed to implement the system functions required of the host, for example, accepting GPS location updates from customer mobile devices, updating associated data records, calculating which merchant offers are relevant to each customer, and forwarding the lists of relevant offers to each mobile.

The server is further connected via a data connection such as TCP/IP over Ethernet to a data network, such as the internet 507. The internet 507 is, in turn, connected to a wireless network 508, enabling communication of bidirectional information packets to both merchant wireless devices and customer mobile devices. The combination of the wireless network 508 and the data network 507 are also shown as FIG. 1, 105

FIG. 6 shows a schema representation of the information structure for one embodiment of a merchant offer. Individual data fields are represented by the labels in quotes, and some representative values are indicated. This information structure is generated in the merchant terminal devices FIG. 1, 110, 112 transmitted through network FIG. 1, 105, and stored in the host database FIG. 5, 502. The information structure is further transmitted to customer mobile terminals, for example, FIG. 1, 104 when the customer terminal is nearby the merchant who generated the merchant offer.

FIG. 7 shows a screen view of a merchant offer. This offer can be displayed on the merchant terminal during offer creation, and will be included in a list of nearby offers that are seen by the client. In the current embodiment, offers are vertically concatenated in a scrollable list, but other similar methods of displaying a list of offers are available including popular ‘swiped’ lists, sequential timed display, grid display, and several other well known display techniques. The screen view is displayed on the screen of the customer terminal as in FIG. 4 and FIG. 1, 104.

While the Applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

Except to the extent necessary or inherent in the processes themselves, no particular order to steps or stages of methods or processes described in this disclosure is intended or implied. In many cases the order of process steps may be varied without changing the purpose, effect, or import of the methods described.

We claim:

1. A system containing a process loaded into a computer memory and operationally configured to display information regarding nearby merchant offers on mobile customer terminals comprising:
providing merchant devices with information regarding the number of nearby potential customers;
providing additional information about the characteristics of nearby potential customers to the merchants;
informing nearby potential customers of the offers from the merchants.

2. The system of claim 1 where the proximity to the of the potential customers is calculated from information obtained from a GPS system.

3. The system of claim 1 where the location of the potential customers is calculated with information obtained by triangulation or location beacons.

4. The system of claim 1 where the merchant offers are assigned a validity period in which the offers are displayed to the potential customer during that validity period.

5. The system of claim 1 where the additional information is given to merchants about nearby potential customers interests or preferences.

6. The system of claim 1 where the offers from merchants are resent by potential customers to social media distribution systems.

7. The system of claim 1 where the system provides directional instructions to the potential customers from each customer's location to the merchant's location.

8. The system of claim 1 whereby the offers from merchants include additional offers of discounts, affinity points, additional goods and services, or offers of future services.

9. A system containing a process loaded into a computer memory and operationally configured to confirm the effectiveness of merchant offers comprising:
providing merchant terminals with information regarding the number of nearby potential customers;
providing additional information about the characteristics of nearby potential customers to the merchants;
informing nearby potential customer terminals of the offers from the merchant terminals;
providing a code associated with each offer from a merchant terminal to nearby potential customer terminals;
providing a counting means to tabulate the number of customers who have responded to each offer;
providing a means for displaying the effectiveness of an offer.

10. The system of claim 9 where the effectiveness measurement is calculated from at least one of: number of customers who responded to the offer, average time from offer to response, top tags of customers who responded, customers who entered store but did not purchase.

11. The system of claim 9 where the effectiveness measurement is compared to historical effectiveness of advertising offers to demonstrate trends in effectiveness over time.

12. The system of claim 9 where the effectiveness measurement is compared to external factors including at least one of: weather, day of week, season, economic indicators, holidays, time of day.

13. A method of providing merchants with the ability to send advertising messages to select potential customers comprising:
providing merchants with a device for interrogating the number of nearby potential customer terminals;
providing a mechanism for constructing an advertising message;
providing the means to selectively distribute the advertising message to potential customers who are nearby.

14. The method of claim 13 whereby the advertising message is further restricted to those potential customer terminals with specific characteristics.

15. The method of claim 13 whereby additional information relating to nearby customer characteristics is presented to the merchant.

16. The method of claim 13 whereby the advertising messages are selectively distributed to select potential customer terminals within a set travel time to the merchant location.
